(19) United States
(12) Patent Application Publication
(10) Pub. No.: US 2026/0043431 A1
(43) Pub. Date: Feb. 12, 2026

(54) INSTRUMENTED ASSEMBLY SCREW

(71) Applicant: SAFRAN AIRCRAFT ENGINES, Paris (FR)

(72) Inventors: Sébastien Georges Roger GOUX, Moissy-Cramayel (FR); Alexis Didier Camille AMBRAZAS, Moissy-Cramayel (FR)

(73) Assignee: SAFRAN AIRCRAFT ENGINES, Paris (FR)

(21) Appl. No.: 19/103,687

(22) PCT Filed: Aug. 16, 2023
(86) PCT No.: PCT/FR2023/051270

§ 371 Date: Feb. 13, 2025

(30) Foreign Application Priority Data
Aug. 17, 2022 (FR) FR2208344

(51) Int. Cl. F16B 31/02

(52) U.S. Cl. CPC F16B 31/02; F16B 2031/022

(57) ABSTRACT

An assembly screw including at least a threaded part and a non-threaded part, the non-threaded part being equipped with a strain gage sensitive to the instantaneous elongation of the non-threaded part and with an RFID tag connected to the strain gage by a wired link, the assembly allowing the wireless transmission of an electrical resistance value of the strain gage representative of the instantaneous elongation.

### TECHNICAL FIELD

This invention relates to the field of controlled tightening and more specifically the kind involving manual wrenches, such as torque wrenches with a release mechanism or direct-reading torque wrenches (mechanical or electronic).

### PRIOR ART

The tightening of screw parts can be controlled with different methods, namely by measuring the torque (clamping force), the rotation angle (conversion of the elongation of the screw body with the thread pitch) or else the elongation of the screw.

Angle tightening is in widespread use in the automotive industry. This can be implemented with a manual wrench that comprises means for measuring the tightening angle. Elongation tightening is used for long screws also known as ties (manual, hydraulic, or thermal elongation method). Torque tightening, on the other hand, is the most commonly used method, using either wrenches with a release mechanism or electronic wrenches, and has the advantage of being simple to use. However, it has the major drawback that for a given tightening torque, the force on the screw parts, and thus the resulting mechanical deformation, varies greatly following the significant dispersion of the apparent friction coefficient (threading, screw head bearing, face of the nut, lock etc.), torsion of the screw body etc.

For Teflon-based lubricants for example, such as those used on cryogenic engines, experience has led to a dispersion in the order of 300% on this coefficient being taken into consideration when dimensioning screwed or bolted couplings. The size of this dispersion gives rise to many difficulties or even impossibilities in the dimensioning of the setpoint torque. Specifically, in the design stage and for a torque tightening, it is necessary to take into account the extreme limits of the envelope of variation of the friction coefficient, i.e. both the low coefficients which determine the mechanical strength of the assembly, and the higher coefficients which are responsible for the quality of tightening of these couplings (sufficient compression of the seals, sufficient tightening of the flanges, etc.).

Such a situation is unsatisfactory since it leads to an over dimensioning of the couplings which is detrimental, both from the point of view of mass, and with regard to the mechanical behavior of the screw parts over time (fatigue, loosening etc.).

Moreover, it is necessary to take into account the mechanical deformation of the screw parts resulting from the tensile force applied to them. Specifically, during a tightening operation, one initially has an elastic (i.e. reversible) deformation region, in which the deformation varies linearly with force, then, if the tightening continues, a plastic (i.e. irreversible) deformation region, in which the deformation varies more and more rapidly with stress, to end in failure. The result of this behavior is that torque tightening, leading to a very dispersed tensile force, must preferably be done in the elastic deformation region of the screw parts well away from the elastic limit.

Wrenches currently exist which allow the control either of the torque alone (wrenches with a release mechanism, direct-reading or ultrasonic wrenches), or simultaneously of the torque and the angle of rotation or the elongation in order to perform a tightening of screw parts equivalent to a desired setpoint value for the torque and/or the angle of rotation or the elongation. Torque-tightening devices also exist with sophisticated processing means which make it possible to increase the precision of the tightening in successive stages.

However, in all these cases, the value of the tightening is guaranteed by the wrench alone, which, with use, can unfortunately lose precision. In addition, following a human error, an incorrect calibration of the wrench may occur or, worse still, an omission of tightening.

This type of control via the wrench alone thus also appears unsatisfactory, and there is therefore a need for an alternative solution guaranteeing the complete tightening of these tightened or bolted couplings under any circumstances by knowing the instantaneous tensile force exerted on the screw parts, a parameter that determines the quality of the tightening and its durability.

### SUMMARY OF THE INVENTION

This invention thus has the main aim of solving the aforementioned problem by allowing for real-time knowledge of the value of the tightening torque. Another aim is to ensure this knowledge once the coupling has been made and possibly become inaccessible. Yet another aim is to be able to be informed at any time of any loss of tightening.

These aims are achieved by an assembly element including at least a threaded part and a non-threaded part, characterized in that the non-threaded part is equipped with a strain gage sensitive to the instantaneous elongation of the non-threaded part and with an RFID tag connected to the strain gage by a wired link, in order to allow the wireless transmission of an electrical resistance value of the strain gage representative of the instantaneous elongation.

Thus, by relaying the instantaneous elongation of the elongated section of screw, control of the tightening torque becomes possible at any time, whether or not the assembly screw is accessible.

The assembly screw can include two threaded end parts separated by a non-threaded central part.

According to the envisioned embodiment, the strain gage can be bonded or printed onto the non-threaded part of the assembly screw and the RFID tag can be bonded or printed onto the non-threaded part of the assembly screw.

The strain gage is advantageously a uniaxial tensile resistance strain gage linked by wire to the RFID tag.

The RFID tag advantageously includes an active storage chip and a UHF antenna.

When the strain gage and the RFID tag are printed, the wired link is also printed onto the non-threaded part of the assembly screw.

The invention also relates to a system for determining the tightening torque of an assembly screw including an assembly screw as mentioned above and an RFID reader including an RFID antenna and an RFID chip to receive the electrical resistance value delivered by the strain gage of the assembly screw, a processing module to determine a tightening torque from this electrical resistance value, and a display to display the determined tightening torque.

Advantageously, the RFID reader includes sonic or light-emitting means to provide an alert in the event of loss of tightening.

### BRIEF DESCRIPTION OF THE DRAWINGS

Other features and advantages of this invention will become apparent from the description given below, with reference to the appended drawings which illustrate an exemplary embodiment without any limitation and on which:

FIG. 1 is a section view of a wrench used for the tightening of an assembly screw, and

FIG. 2 shows an instrumented assembly screw according to the invention.

### DESCRIPTION OF THE EMBODIMENTS

The principle of the invention is based on the instrumentation of an assembly element, screw, stud or bolt, so as to know, in real time, a feature representative of the value of the tightening torque in order to transmit it to an external processing module capable of exploiting this value.

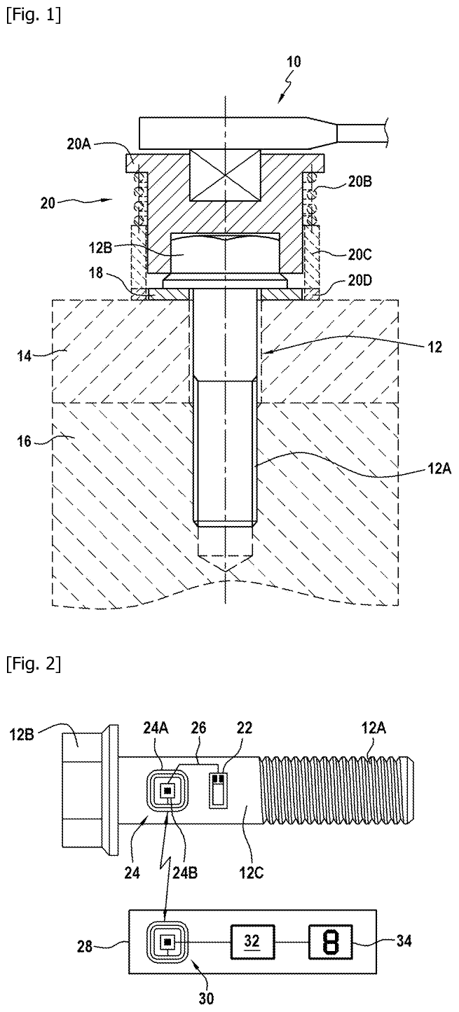

FIG. 1 illustrates an example of a wrench 10 used for the tightening of an assembly screw 12 in order to assemble a first part 14 with a second part 16 tapped to receive the threaded part 12A of the assembly screw. A washer 18 is mounted between the head 12B of the assembly screw and the first part 14. The angle of rotation is measured by a measuring device 20 which comprises a clamping bush 20A interacting with the head 12B of the assembly screw and which measures the differential rotation between the bush 20A and the first part 14 by means of a spring 20B disposed around the outer periphery of the bush, a Teflon® tube 20C, provided with a non-slip ring 20D, being inserted between the spring 20B and the upper surface of the first part 14. The Teflon® tube makes it possible to generate a low friction coefficient between the movable parts to avoid affecting the tightening torque.

This measurement configuration by means of a spring is of course in no way limiting and an optical, magnetic or electrical (rheostat-type) measurement replacing both the spring and the clamping bush is quite possible.

Whatever the chosen configuration, the wrench also includes inputting means for defining a setpoint value for the tightening, and processing means for computing the tightening torque based on the angle of rotation delivered by the measuring device 20 and informing the operator (conventionally by a sonic and/or light-emitting signal) when the initially-defined setpoint has been reached. It is valid to refer to the application FR2852879 for more details about the computations involved in this determination of the tightening torque based on the angle of rotation.

However, as explained in the introduction, once the coupling has been made and the wrench removed, no further control over time of the tightening torque is possible, particularly the control of any loss of tightening.

Thus, according to the invention and as shown in FIG. 2, the non-threaded part 12C of the assembly screw 12 is equipped with a strain gage 22 and with an RFID (Radio Frequency IDentification) tag 24 connected to one another by a wired link 26. The RFID tag is intended to interact remotely with an RFID reader 28, advantageously portable, including an RFID antenna/chip set 30 connected to a processing module 32 itself connected to a display 34 and/or to a loudspeaker. The display and/or the loudspeaker may constitute a sonic and/or light-emitting alert device for the operator in the event of loss of tightening. The assembly screw and RFID reader set forms a system for determining the tightening torque of an assembly screw including at least a threaded part and a non-threaded part in order to allow the wireless transmission of an electrical resistance value of the strain gage representative of the stretching of this assembly screw.

The strain gage (a resistance wire extensometer conventionally manufactured by a lithographic process from a metallic sheet of a few microns and an electrical insulator of polyamide type), is preferably bonded onto this non-threaded part in order to detect an instantaneous elongation causing a change in the electrical resistance of the strain gage. Stick-on resistance strain gages, particularly uniaxial tensile gages, are known to the instrumentation sector (characterized by size, resistance to heat/corrosive environments and bonding onto different substrates). However, the gage could also be directly produced by printing onto the shank (non-threaded part) of the screw itself.

The RFID tag, which can similarly be bonded onto the non-threaded part of the assembly screw, includes an antenna 24A connected to a processing module 24B (the so-called RFID storage chip) including a memory and transmission/reception means intended to interact with corresponding means of the RFID reader 28. Stick-on RFID tags are known (characterized by size, integration/substrate, distance of detection by the reader, memory capacity, active or passive nature). However, the tag could also be directly produced by printing onto the shank (non-threaded part) of the screw itself. Depending on the frequency environment as well as the detection distance (power characterized by the frequency range: low (Low Frequency, LF 125 kHz)/high (High Frequency, HF 13.56 MHz)/Ultra-high (Ultra-High Frequency, UHF 433 and 860-960 MHz)/Super-high (Super-High Frequency, SHF 2.45 GHz)), different frequency ranges and associated antennas will be usable.

The strain gage and the RFID tag are linked by two measuring wires forming the wired link 26. When the two aforementioned elements are printed the wired link is advantageously also printed.

The placing of the strain gage on the shank (non-threaded part) of the assembly screw makes it possible to determine an electrical resistance value dependent on the instantaneous elongation of this shank, which value will be stored in the memory of the RFID chip and will therefore be able to be read at any time by the RFID reader. An appropriate processing known per se will allow the processing module 32 of the RFID reader to deduce the tightening torque from this value of the electrical resistance and to present it to the operator on the display 34 of the RFID reader.

According to the nature of the RFID chip, active or passive, automatic feedback of information to the RFID reader may be envisioned, particularly with a sonic and/or light-emitting alert in the event of loss of tightening at this RFID reader. A code associated with the torque information will precisely designate the position of the screw in the bolted assembly.

Note that although the previous description has concerned a conventional screw, it is clear that it is also applicable to a headless screw (or stud) with a double thread, of which the non-threaded central part between the two threads would be equipped with the strain gage and the RFID tag mentioned above.

1. A system for determining the tightening torque of an assembly screw including an assembly screw and an RFID reader including an RFID antenna and an RFID chip to receive the electrical resistance value delivered by the strain gage of the assembly screw, a processing module to determine a tightening torque from this electrical resistance value, and a display to display the determined tightening torque, wherein the assembly screw includes at least a threaded part and a non-threaded part, the non-threaded part being equipped with a strain gage sensitive to the instantaneous elongation of the non-threaded part and with an RFID tag connected to the strain gage by a wired link, in order to allow the wireless transmission of an electrical resistance value of the strain gage representative of the instantaneous elongation, wherein the strain gage is printed on the non-threaded part of the assembly screw and in that the RFID tag is printed on the non-threaded part of the assembly screw, and in that the RFID reader includes sonic or light-emitting means to provide an alert in the event of loss of tightening.

2. A system as claimed in claim 1, wherein the assembly screw includes two threaded end parts separated by a non-threaded central part.

3. A system as claimed in claim 1, wherein the wired link is printed on the non-threaded part of the assembly screw.

4. A system as claimed in claim 1, wherein the strain gage is a uniaxial tensile resistance strain gage linked by wire to the RFID tag.

5. A system as claimed in claim 1, wherein the RFID tag includes an active storage chip and a UHF antenna.

6. (canceled)

7. (canceled)
